(19) United States
(12) Patent Application Publication
(10) Pub. No.: US 2010/0271817 A1
(43) Pub. Date: Oct. 28, 2010

(54) LED TABLE LAMP

(75) Inventors: SHIN-HONG CHUNG, Taipei Hsien (TW); TSUNG-HUAN HSIEH, Taipei Hsien (TW); WEN-HSIANG LU, Taipei Hsien (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/606,115

(22) Filed: Oct. 26, 2009

(30) Foreign Application Priority Data
Apr. 28, 2009 (CN) 200920302659.7

(51) Int. Cl. F21V 7/00; F21S 6/00

(52) U.S. Cl. 362/234; 362/235; 362/294

(57) ABSTRACT

An LED table lamp includes a base; a support arm with an end connected to the base; a power input disposed in the base configured for receving power; a lamp body pivotally connected to another end of the support arm; an LED light module, composed by several LED dies and a circuit board connected in a manner of series or parallel; and a light filter disposed on light path of the lamp body, configured for making light emitted from the light emitting device uniform.

### BACKGROUND

1. Technical Field

The disclosure relates to table lamps, and more particularly to a light emitting diode (LED) table lamp.

2. Description of Related Art

In general, light emitting diode (LED) table lamps in the market use LED light panels composed of dozens or even hundreds of LED dies. However, because the LED dies are point light sources, light generated by the table lamp may be not uniform due to interference of two coherent point light sources.

Therefore, it is useful to provide an LED table lamp to overcome the above-mentioned shortcoming.

### BRIEF DESCRIPTION OF THE DRAWINGS

The components in the drawing are not necessarily drawn to scale, the emphasis instead being placed upon clearly illustrating the principles of the LED lamp.

FIG. 1 is a schematic view showing a light emitting diode (LED) table lamp of one preferred embodiment of the present disclosure.

FIG. 2 is a cross-sectional view showing inner structure of a lamp body of the LED table lamp of FIG. 1.

### DETAILED DESCRIPTION

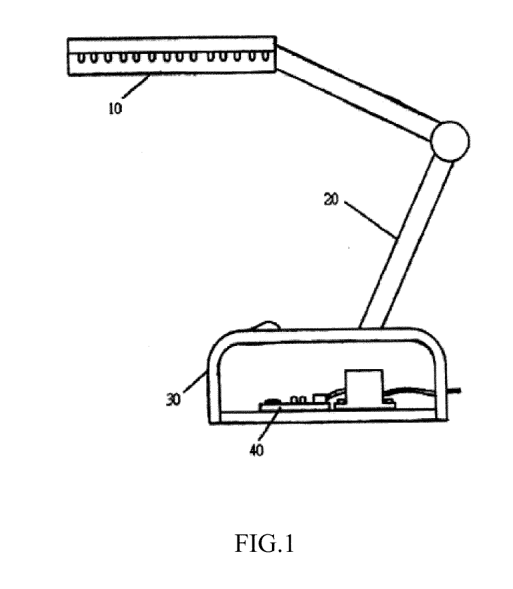

FIG. 1 is a schematic view showing a light emitting diode (LED) table lamp of one exemplary embodiment of the present disclosure. The LED table lamp 100 includes a lamp body 10, a support arm 20, a base 30, and a power input 40. The lamp body 10 is pivotally connected to one end of the support arm 20. Another end of the support arm 20 is connected to the base 30. The power input 40 is disposed in the base 30 for receving power from a power source or batteries.

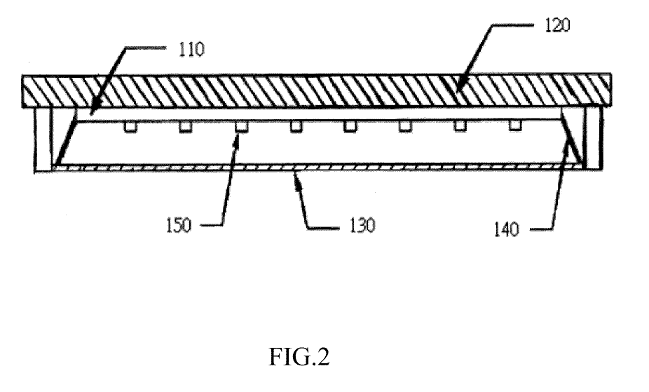

FIG. 2 is a cross-sectional view showing inner structure of the lamp body of the LED table lamp of FIG. 1. The table lamp 100 further includes an LED light module 110, a heat pipe 120, a light filter 130, and a reflector 140, which are all disposed in the lamp body 10.

The LED light module 110 includes several LED dies 150 and a circuit board (not shown) connected in a manner of series or parallel. Light emitted from the LED light module 110 travels directly out of the lamp body 10.

The heat pipe 120 may be disposed on the surface of the circuit board of the LED light module 110. The heat pipe 120 has a good heat conduction efficiency to dissipate the heat produced by the LED light module 110. Heat generated from the LED light module 110 may be effectively conducted to the heat pipe 120, as a result heat produced by the LED module 110 can be effectively dissipated. Therefore, the LED light module 236 may work at an optimal working temperature, and the LED table lamp 1 has a longer working lifespan.

The light filter 130 such as a lens or film is disposed on light path of the lamp body 10 for intercepting light from the lamp body 10, so that the light emitted from the light emitting device 220 is polarized, diffused and more uniform.

The reflector 140 is disposed inner the lamp body 10 and adjacent to the LED light module 110 and the light filter 130. The light emitted from the LED light module 110 is reflected several times by the reflector 140 to increase the uniformity of the optical mixing. Therefore, light emitting out of the lamp body 10 may have a substantially uniform brightness.

The LED table lamp 1 may further include a humidifier (not shown) disposed on the base 30 or the support arm 20 or other appropriate part of LED table lamp 1 to increase humidity (moisture) around the LED table lamp 1. The humidifier may be any kind of common humidifier, such as an vaporizer and ultrasonic humidifier.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An LED table lamp comprising:
a base;
a support arm, with an end connected to the base;
a power input, disposed in the base configured for receving power;
a lamp body, pivotally connected to another end of the support arm;
an LED light module, composed by several LED dies and a circuit board connected in a manner of series or parallel; and
a light filter, disposed on light path of the lamp body, and configured for making light emitted from the light emitting device uniform.

2. The LED table lamp according to claim 1, wherein the light filter is a lens.

3. The LED table lamp according to claim 1, wherein the light filter is a film.

4. The LED table lamp according to claim 1, further comprising a reflector, disposed in the lamp body and adjacent to the LED light module and the light filter, and configured for reflecting the light emitted from the LED light module to increase uniformity.

5. The LED table lamp according to claim 1, further comprising a heat pipe, disposed on a circuit board of the LED light module, and configured for dissipating heat produced by the LED module.

6. The LED table lamp according to claim 1, further comprising a humidifier disposed on the base of LED table lamp to increase humidity around the LED table lamp.

7. The LED table lamp according to claim 6, wherein the humidifier is an vaporizer.

8. The LED table lamp according to claim 6, wherein the humidifier is an ultrasonic humidifier.

9. The LED table lamp according to claim 1, further comprising a humidifier disposed on the support arm of LED table lamp to increase humidity around the LED table lamp.

10. The LED table lamp according to claim 9, wherein the humidifier is an vaporizer.

11. The LED table lamp according to claim 9, wherein the humidifier is an ultrasonic humidifier.
